(19) United States
(12) Patent Application Publication
(10) Pub. No.: US 2007/0210119 A1
(43) Pub. Date: Sep. 13, 2007

(54) Dispensing cap

(75) Inventor: Keith D. Alsberg, Chicago, IL (US)

Correspondence Address: BRINKS HOFER GILSON & LIONE, P.O. BOX 10395, CHICAGO, IL, 60610, US

(73) Assignee: Square 1 Product Development

(21) Appl. No.: 11/372,548

(22) Filed: Mar. 10, 2006

(51) Int. Cl. G01F 11/10

(52) U.S. Cl. 222/361

(57) ABSTRACT

A dispensing cap device for a container is described, with an integral measuring mechanism for dispensing a predetermined quantity of the contents of the container. The dispensing cap device dispenses a predetermined quantity of powder or similar material each time the mechanism is actuated. A dispensing cycle may include placing the container in an inverted position; filling a dose chamber in a shuttle drawer by aligning the dose chamber with a filling aperture in the cap body; and, applying force to an end of the shuttle drawer so that the dose chamber is aligned with a dispensing aperture.

### TECHNICAL FIELD

This application relates to a device for dispensing material, and more specifically to a cap for a container, the cap being suitable for dispensing a known quantity of material.

### BACKGROUND

Various products for consumer and industrial use are stored in containers such as jars or similar shaped containers made of glass, metal or plastic. The contents are often intended to be dispensed in standard measures, which may be called a dose. For consumer products, a typical dose may be a teaspoon or a tablespoon. While these doses have precise definitions, the size of actual tableware, and whether the dose is a level teaspoon or a heaping tablespoon leads to large variations in the quantity of material removed from the container, depending on the person performing the dispensing operation and the specific implement used. Apart from lack of uniformity, the use of tableware for dispensing such products may be inconvenient as the implement may not be conveniently available. There have been attempts at designing individual dose dispensing devices for containers, but the lack of adoption of such devices may be attributable to the cost, awkwardness in using the device and the like. The container is usually stored in an upright position and must be inverted for use.

A simple, convenient, means of dispensing materials is needed.

### SUMMARY

A dispensing cap device (or closure) for a container is described, with an integral measuring mechanism for dispensing a predetermined quantity of the contents of the container. The dispensing cap device measures or “doses” a predetermined quantity of powder or similar material each time the mechanism is actuated. The components of the device include a cap body, a shuttle drawer, and a return spring. The cap body serves to captivate the cap device to a container and has a slide channel. The slide channel defines a path of motion for a shuttle drawer, such that the shuttle drawer can travel linearly inside the cap body, in a direction parallel to the plane of the container opening. The slide channel surfaces are sized and dimensioned such the shuttle drawer mates slidably to the cap body with minimal clearance except in the desired direction of motion. Sliding surfaces may be crowned in one direction; that the surfaces need not be planar, but may be cylindrical sections or the like.

The slide channel is open on one end to permit the shuttle drawer to project from a side surface of the cap body in one state. The device may be actuated by applying a force to the portion of the shuttle drawer projecting from the cap body so as to urge the shuttle drawer into the cap body. When the exposed end of the shuttle drawer is actuated by the user, the shuttle drawer slides into the cap body against the force of the return spring. (In an alternative, the shuttle drawer may be retained in an inserted position against the spring force, and released by the user actuation.

The cap body has a first surface facing the interior of the container and a second surface facing the exterior. A filling aperture is disposed in a first surface of the cap body and a dispensing-aperture is disposed in a second surface of the cap body. A dose chamber is disposed in the shuttle drawer such that it extends from the surface of the shuttle drawer mating with the first surface and the surface of the shuttle drawer mating with the second surface, and defines a volume corresponding to desired dose The filling aperture and the dispensing aperture are spaced apart from each other so that the dose chamber in the shuttle drawer can be positioned separately opposite the fill hole and the dispense hole by a sliding motion of the shuttle drawer. The filling and dispensing apertures are sized and dimensioned so that the dose chamber can communicate with at most only one of the apertures for any position of the shuttle drawer.

The range of travel of the shuttle drawer may limited such that, for example, the “out” position corresponds to alignment of the dose chamber with the filling aperture, and the “in” position corresponds to alignment of the dose chamber with the dispensing aperture. In an embodiment, a return spring urges the shuttle drawer toward resting in the “out” position when no user force is applied to the exposed portion of the shuttle drawer.

The dose chamber is configured so that one of the surfaces thereof, extending between opposing mating surfaces of the shuttle drawer has an arcuate shape, with a radius of curvature commensurate with that of the opening of the container body. The opposing surface may have arcuate shape having a similar radius of curvature. The distance between the opposing surfaces is determined so that, when the dose chamber is full of material, the volume of material corresponds to the intended dose to be dispensed.

A dispensing cycle may include the steps of: placing the container in an inverted position (that is, with the container opening lower than the contents of the container); filling the dose chamber by aligning the dose chamber with the filling aperture in the cap body; transitioning the dose chamber from alignment with the filling aperture to a position intermediate between the filling and dispensing apertures by applying force to an end of the shuttle drawer; dispensing by aligning the dose chamber with the dispensing aperture; returning the shuttle drawer to an initial position.

The cap device can be removeably attached to the container with threads, a bayonet mount, a snap-fit bead, or other conventional means, or permanently attached to the container by sonic welding, bonding, a snap-lock bead, or other conventional means. The material to be dispensed may be a powder but could also be granular, pelletized, balls, micro-spheres or similar flowable non-liquid material. The cap body and the shuttle drawer may each be injection molded as single components. The material to be dispensed may be fed by gravity as described above, but could be fed by other means such as pneumatic pressure, centrifugal pressure, or buoyancy.

### BRIEF DESCRIPTION OF THE DRAWINGS

FIG. 1 is a perspective exploded view of the dispensing cap;

FIG. 2A and FIG. 2B are perspective cross-sectional views of the dispensing cap, showing the relative position of the components in three operating states of the dispensing drawer;

FIG. 3 shows the relationship of an arcuate dose chamber to the material container opening for three operating states of the dispensing drawer;

FIG. 4 shows cross sections and plan views of the dispensing cap with respect to a container and material to be dispensed during a dispensing cycle;

FIG. 5 is an exploded perspective view of a first example of a latching mechanism;

FIG. 6 is a perspective view of a second example of a latching mechanism; and,

FIG. 7 is a perspective view of a third example of a latching mechanism.

### DETAILED DESCRIPTION

The examples described herein may be better understood with reference to the drawings, but these examples are not intended to be of a limiting nature. Like numbered elements in the same or different drawings perform equivalent functions.

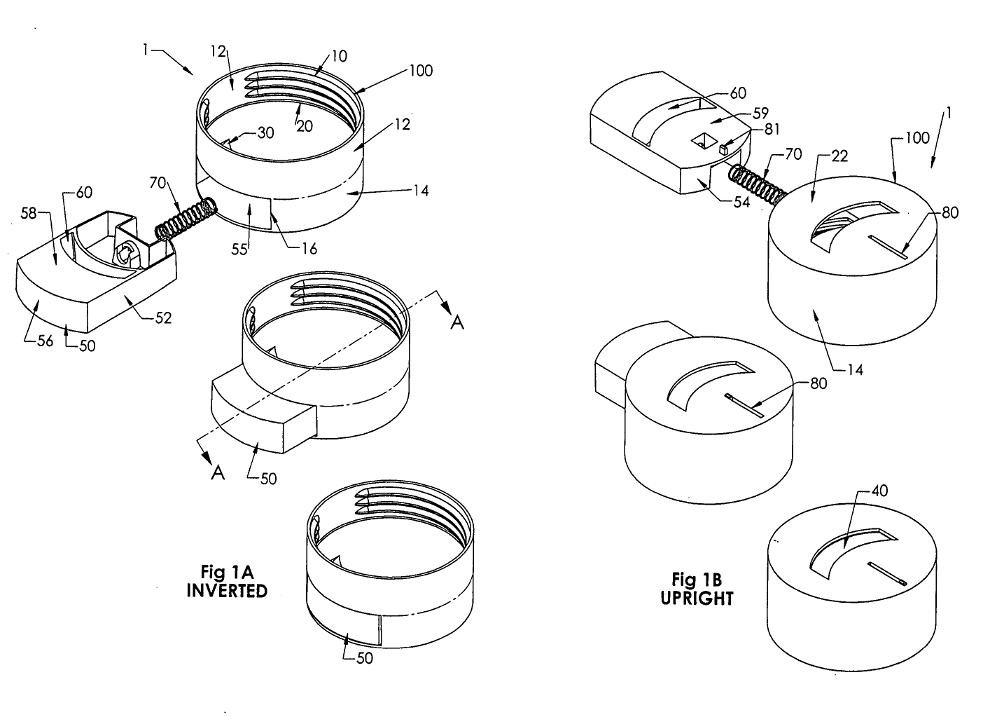

FIG. 1 shows an exploded view of a dispensing cap 1. In this example, the cap 1 is intended to be secured to a container (not shown) having a circular opening in one end, such as a jar for containing iced tea mix, powdered milk or the like. The orientation of the cap 1 in FIG. 1A is consistent with the jar being inverted so that the opening in the jar is below the remainder of the jar. This is inverted from a typical storage position where the cap is up. FIG. 1B is a view of the dispensing cap 1 in an upright position. The dispensing cap 1 is comprised of two moldable components, a cap body 100 and a drawer 50, and may have a spring 70 inserted therebetween.

Screw threads 10 may be used to engage with corresponding structures on the jar so as to retain the dispensing cap on the jar as is conventional. In a similar manner, snap on caps, permanently affixed caps and the like are also equally satisfactory, the choice being related to the type of product being dispensed and costs.

A first planar surface 20 of the cap is similar to the cap top in conventional caps and closes the end of the cylindrical structure 12 supporting the screw threads 10. A filling aperture 30 is formed in a portion of the first surface 20, and may have a beveled edge 32 so as to facilitate introducing material from the container into the filling aperture 30 when the jar is in an inverted position.

The cylindrical structure 12 continues beyond the first surface 20 to from an extension 14, which is seen to be continuous with the surface 12 on the outside of the cap body 100. A second planar surface 22 is disposed parallel to the first surface 20. A dispensing aperture 40 is formed in the second surface 22.

In an aspect, the second surface 22 may be slightly recessed into the cylindrical structure 12, so that when the dispensing cap 1 is attached to a jar and placed on a flat surface in the inverted state, only the rim of the cylindrical structure 14, protruding in a direction distal to the container, would be in contact with the flat surface.

A shuttle drawer 50 is assembled so as to be a part of the dispensing cap 1. The cylindrical mating structure 12, 14 has an aperture 16 sized and dimensioned so as to accept the shuttle drawer 50. As shown, the shuttle drawer has linear sides and generally arcuate ends 54 and 56 so as to be compatible with the shape of the remainder of the cap body 100. However the ends may have other shapes. Mating structures inside of the cap body 100 guide the shuttle drawer 50 into the aperture 55 so that the shuttle drawer 50 translates parallel to the first and second planar surfaces 20, 22.

A dose chamber 60 extends from a first surface 58 of the shuttle drawer 50 to a second surface 59 of the shuttle drawer 50. The plan view shape of the dose chamber 60 corresponds to that of the filling aperture 30 and the dispensing aperture 40 in the cap body 100. The dose chamber has interior side walls to isolate the dose chamber 60 from the remainder of the shuttle drawer 50.

In an aspect, a spring 70 is fitted between an end of the shuttle drawer 50 and an interior surface of the cylindrical portion 14 of the cap body 100. The spring 70 is disposed so as to urge the shuttle drawer 50 out of the cap body 100 through the aperture 40 in the side of the cylindrical wall 14. In operation, the shuttle drawer 50 is prevented from becoming detached from the cap body 100 by a retaining arrangement. In this example, a slot 80 is formed in the second surface 22 of the cap body 100 and a tab 81 is disposed on second surface 59 of the shuttle drawer 50 and arranged such that the tab 81 engages the slot 80 when the shuttle drawer 50 and the cap body 100 are assembled with the spring 70 disposed therebetween. Alternatively the slot 80 may be provided on the second surface of the shuttle drawer 50 and the tab 81 may be provided in an interior surface of the second surface 22.

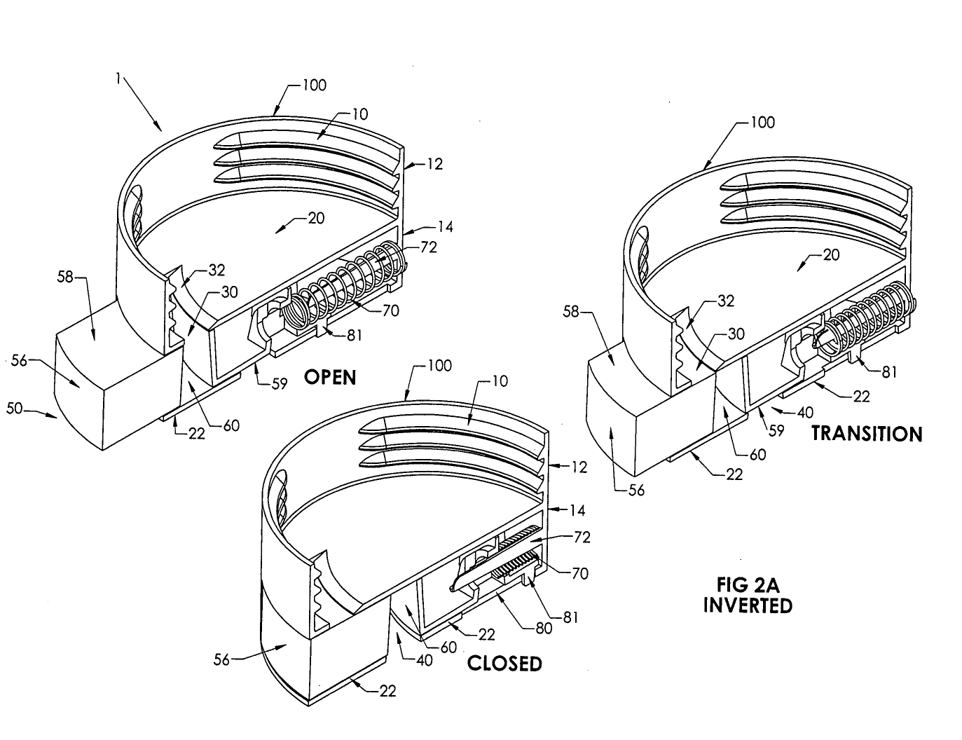

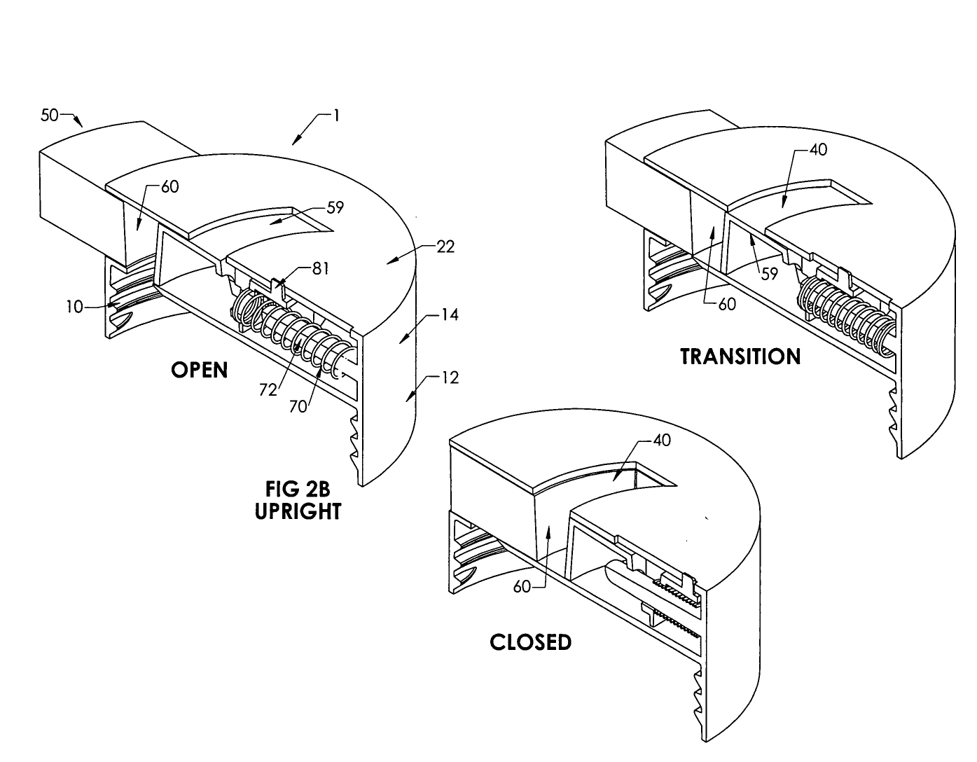

FIGS. 2 A and 2 B are perspective cross-sectional views of the dispensing cap 1 shown in FIG. 1, along a line A-A, which is representative of the cross-sectional orientation. FIG. 2 A corresponds to the inverted position of the container and FIG. 2 B corresponds to the upright position of the container.

As in FIG. 1, the dispensing cap 1 is shown in three states, open, transition and closed. In the example shown, the open state corresponds to an alignment of the filling aperture 30 in the first surface 20 of the cap body 100 with the dose chamber 60 in the shuttle drawer 50. The end of the dose container 60 having an aperture in the second surface 59 of the shuttle drawer 50 is disposed such that the end is facing the second surface 22 of the cap body 100 and the contents of the dose chamber 60 cannot exit from the dispensing cap 1. However, the contents of the container can enter the dose chamber 60 through the filling aperture 30, such that the dose chamber is filled with material from the container.

When pressure is applied to the end surface 56 of the shuttle drawer, shuttle drawer 50 is urged against the resistance of spring 70 so that the shuttle drawer 50 slides partially into the cap body 100. In transition state, the dose chamber 60 is positioned such that the ends of the dose chamber 60 are disposed such that each end is closed off by one of the first surface 20 or the second surface 22 of the cap body 100. In this state, any material that has entered the dose chamber 60 in the open state is now retained such that in can neither return to the container nor exit from the cap body 100 to the exterior.

Continued application of pressure to the end surface 56 further compresses spring 70 so that the end surface 56 of the shuttle drawer 50 is approximately flush with the cylindrical portion 14 of the cap body 100. In this state, the dose chamber 60 is disposed opposite the dispensing aperture 40 in the second surface of the cap body 100, and any material that is within the dose chamber 60 falls out of the dispensing cap 1 due to gravitational acceleration.

In this example, the shuttle drawer 50 will return to an open state when pressure is removed from the end surface 56 of he shuttle drawer 50. Providing that the container remains in the inverted state, material from the container will again enter the dose chamber 60 and the dispensing sequence can be repeated.

FIG. 2 B shows the same sequence of operations as viewed from the outside of the dispensing cap 1. In the upright state, although the motion of the shuttle drawer 50 is the same as described with respect to FIG. 2 A, no material will enter the dose chamber 60 as the container is upright and the dispensing cap 1 is higher than the contents of the container.

The spring 70 may be a coil spring as shown, a leaf spring, a longitudinally compressible tube, a foam material or the like, being capable of resiliently resisting applied force. Materials such as plastics or metals or a combination thereof may be used. When a spring having a slim form factor is used, a mandrill 72 may be provided to guide the spring 70 for all or part of the compression cycle so as to avoid column buckling. The length of the mandrill will depend on the spring properties.

The longitudinal separation between the filling aperture 30 and the dispensing aperture 40 may be greater than the longitudinal width of the dose chamber 60 so that, during the transition state, there is no opening through which material can either enter of leave the dose chamber 60.

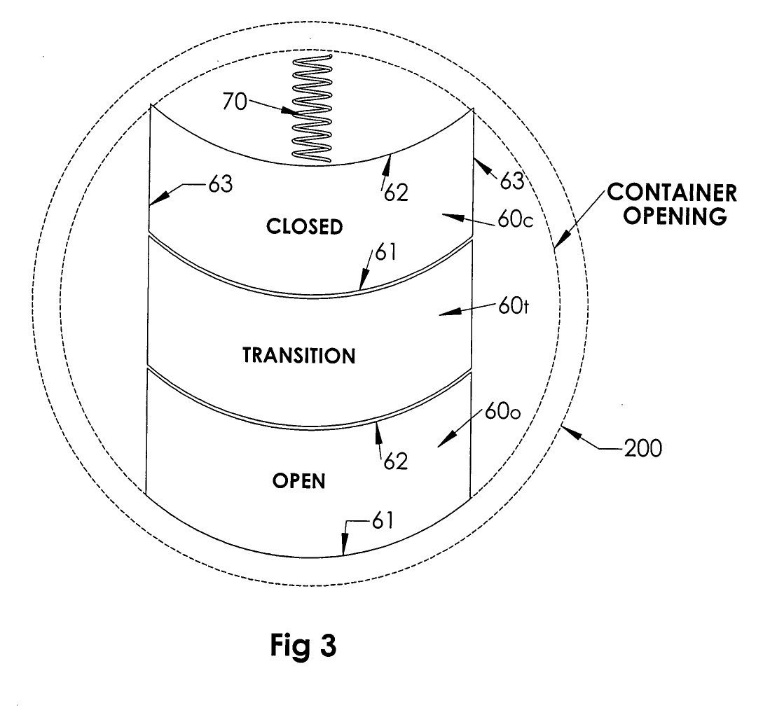

The shape of the dose chamber 60 may be selected to meet requirements for a specific quantity of material to be dispensed, and therefore the volume of the dose chamber 60 is determined to contain the desired quantity of material. When used with containers with a circular opening, as is typical of many product packages, the plan view shape of the dose container 60 may be selected so as to effectively use the area of the aperture of the container. An arcuate shape, as shown in FIGS. 1-3 may be effective in achieving a high efficiency in the use of the container aperture. FIG. 3 is a plan view of a cross-section of the dispensing cap 100 showing only components pertinent to the aspect of the shape of the dose chamber 60.

Dashed lines in FIG. 3 show the cross section of the container aperture 200 on which the dispensing cap 1 is disposed, for example by screwing the dispensing cap 1 to the container using screw threads 10 which engage with corresponding structures on the container. A dose chamber 60 having at least a first arcuate side 61, corresponding in radius approximately to that of the container opening 200 may also have a second arcuate side 62 of the same or similar radius disposed opposite. The remaining sides 63 are straight, or may be any shape consistent with the shuttle drawer 50 being able to slide linearly with respect to the cap body 100. The dose chamber 60 is shown in positions corresponding to a closed state 60c, a transition state 60t and an open state 60o. The arcuate shape of the first side 61 permits the dose chamber 60 to come close to congruence with a portion of the container opening 200 when in the open position, and leaves room for the spring 70 when in the closed position. The radius or shape of the second side 62 may be adjusted to maximize the area of the apertures 30, 40 of the dose chamber 60, consistent with the requirements for housing the spring 70. For a given material dose quantity, maximizing the plan view area of the dose chamber 60 may lead to smaller dimension between the first surface 20 and the second surface 22, thus reducing a dimension of the dispensing cap 1. The radius of the arcuate sides 61, 62 may not be equal and may depend on the amount of material to be dispensed and compatibility with the remainder of the structure. The radius may be selected between approximately twice the radius of the container and half of the radius of the container.

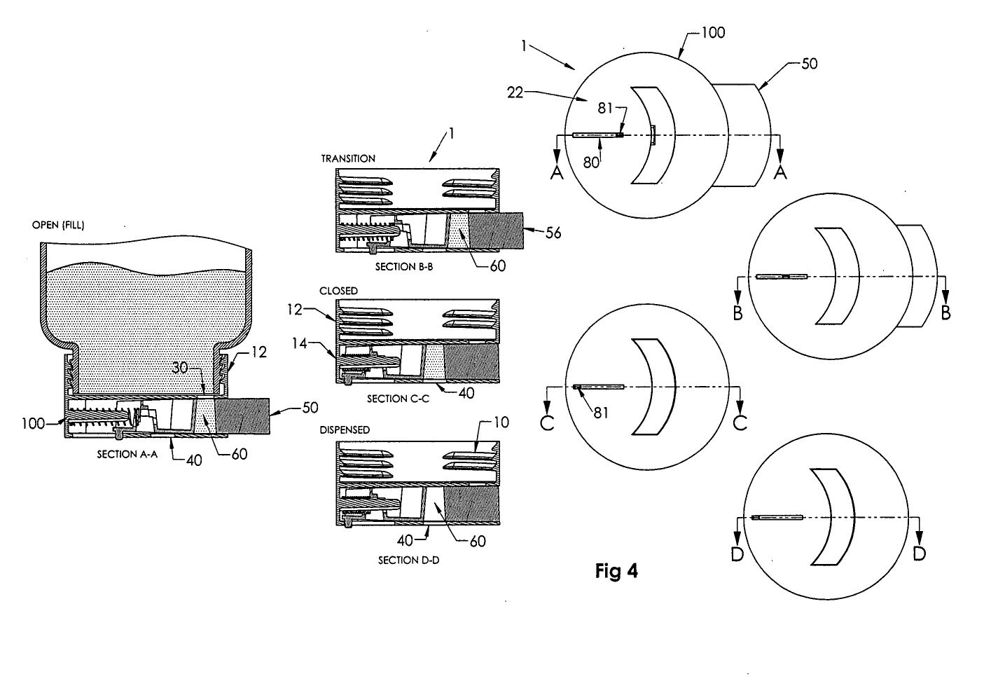

FIG. 4 is a series of plan views and corresponding cross-sectional views of the dispensing cap 1, showing the various states. Stippling indicates loose material. In the inverted state, the container (not shown in the plan view) is above dispensing cap 1, and material in the container, shown by the stippling, fills the space between the cylindrical wall 12 and the first surface 20. In the open state (A-A), the dose chamber 60 is disposed opposite the filling hole 30 in the first surface 20 so that material from the container may enter and fill the dose chamber 60. When pressure is applied to the end piece 56 so that the shuttle drawer 50 is urged into the main cap body 100, the dose chamber 60 becomes closed off at both the upper and lower ends, and no more material can enter. Material cannot leave either. When further pressure is applied and the shuttle drawer 50 continues to slide into the cap body 100, an opening in an end of the dose chamber 60 becomes positioned opposite the dispensing aperture 40, and the material falls out of the dose chamber 60. For clarity, this is shown in two steps at sections C-C and D-D. In practice, the material begins falling out of the dose chamber 60 during the process where the dose chamber 60 moves into position opposite the dispensing aperture 40, so that the situation of cross-section D-D represents the state where the material has been dispensed. At this juncture, the dose chamber 60 is empty of the material.

In the example shown, providing that the container remains in the inverted state when the pressure on surface 56 is removed, the dose chamber 60 will return to the open state and be refilled. If the container is placed in an upright position, the material will either not fill the dose chamber 60, or will flow back out of the dose chamber 60 into the container.

In another example, the positions of the filling aperture 30 and the dispensing aperture 40 may be interchanged in a longitudinal direction. In this situation, the filling opening 30 is positioned near the center of the container 200 aperture and the dispensing opening 40 is positioned near the periphery of the container aperture 200, while each remaining on corresponding surface as in the first example. The effect of interchanging the positions is that the dose chamber 60 is filled in the closed state and the material is dispensed in the open state.

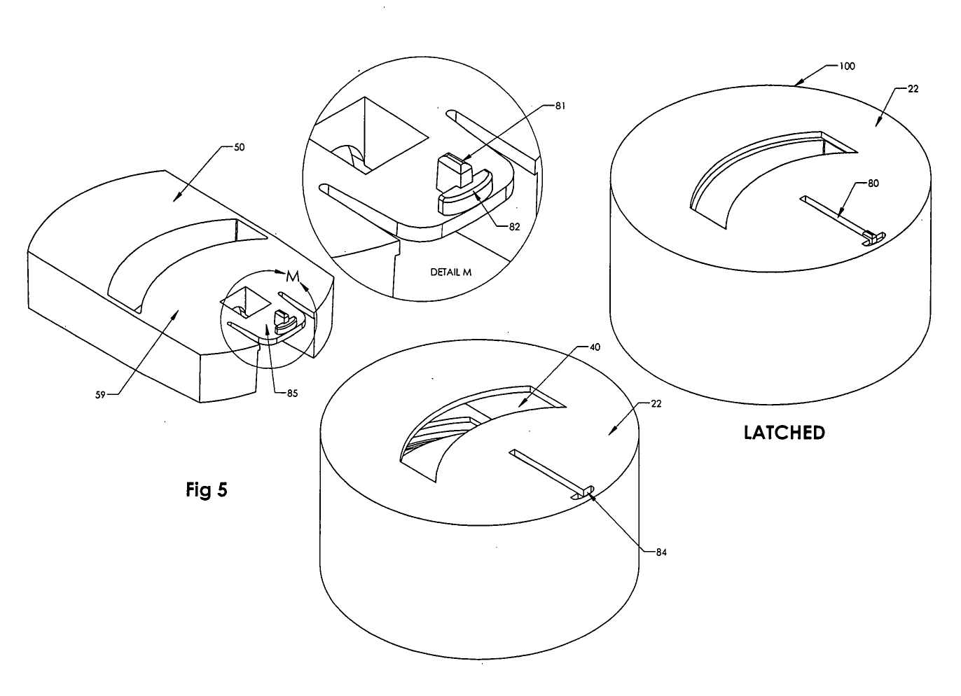

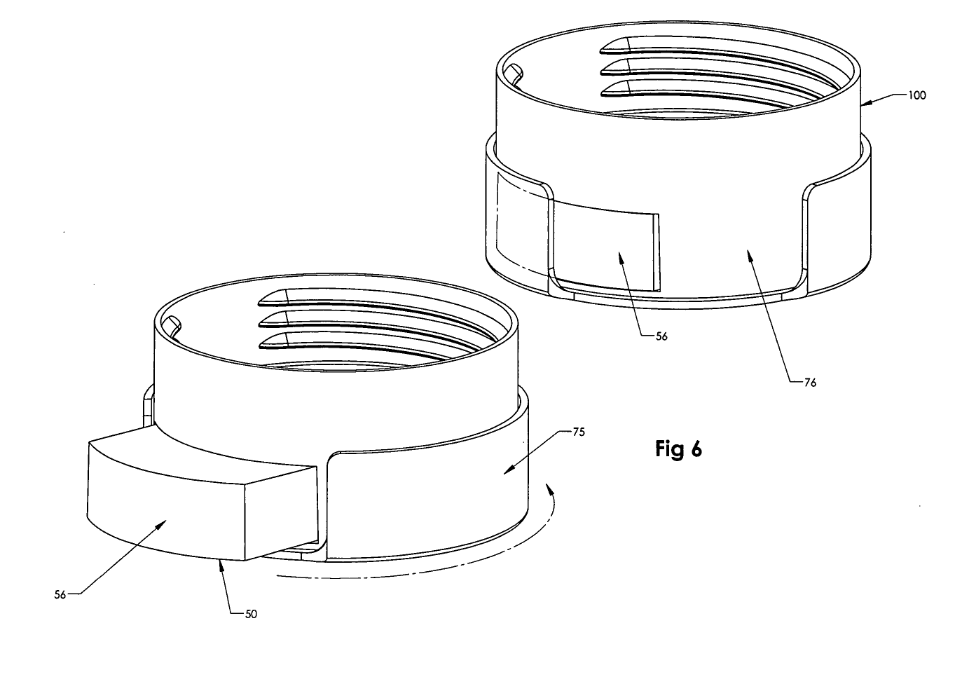

Restraining the shuttle drawer 50 in a closed position may be desirable for some storage applications. A number of structures may be used to restrain the shuttle drawer 50 in a closed position with respect to the cap body 100, and they may be used in the first and second examples. As shown in FIG. 5, a tab 82 may be provided on the surface 59. A corresponding hole 84 may be provided in the second surface 22 and disposed such that the tab 82 engages the hole 84 when the shuttle drawer 50 is in the closed position. The tab 82 may be on a portion of the surface 59 which has been relieved in part so that the tab is on a flexible portion 85 of the surface 22. When the tab 82 is depressed by a finger of the user, it is urged below the outer surface of the second surface 22 and permits the shuttle drawer 50 to slide freely into an open position, being urged to do so by the spring 70 (not shown in FIG. 6). When used in conjunction with the dispensing cap 1 of the first example, the shuttle drawer 50 moves into the open position and may be filled by the contents of the container. The shuttle drawer 50 may then be moved into the closed position to dispense the material from the dose chamber 60. In another aspect, the location of the hole 84 is disposed further from the aperture 40 and the shuttle drawer 50 may be restrained only when the shuttle drawer has been pushed into a position further interior to the cap body 100. This provides the user with the alternative of not engaging the locking mechanism if, for example, multiple doses are to be dispensed.

The hole 84 may be provided at a location along the length of the slot 80, such as at the end of the slot distal from the aperture 40, and may be combined with the tab 81.

Other locking mechanisms may be used. For example, FIG. 6 shows a ring 75, the ring 75 being rotatably secured to the cap body 100 so that the ring 75 may be moved either clockwise or counterclockwise for at least some angular distance. The method of attachment of the ring 75 to the cap body 100 may be by means of interlocking grooves, screw threads, or the like. Rotation by more than 360 degrees may not be required. The ring 75 has an aperture 76 having a dimension in the circumferential direction that is greater than that of the shuttle draw surface 56, and a dimension and disposition in the height direction such that the aperture has a dimension and disposition in the height direction such that the shuttle drawer 50 may pass through the aperture for at least one rotational position of the ring 75. As shown, the aperture is in the form of a “U”, however, a substantially rectangular opening may be used.

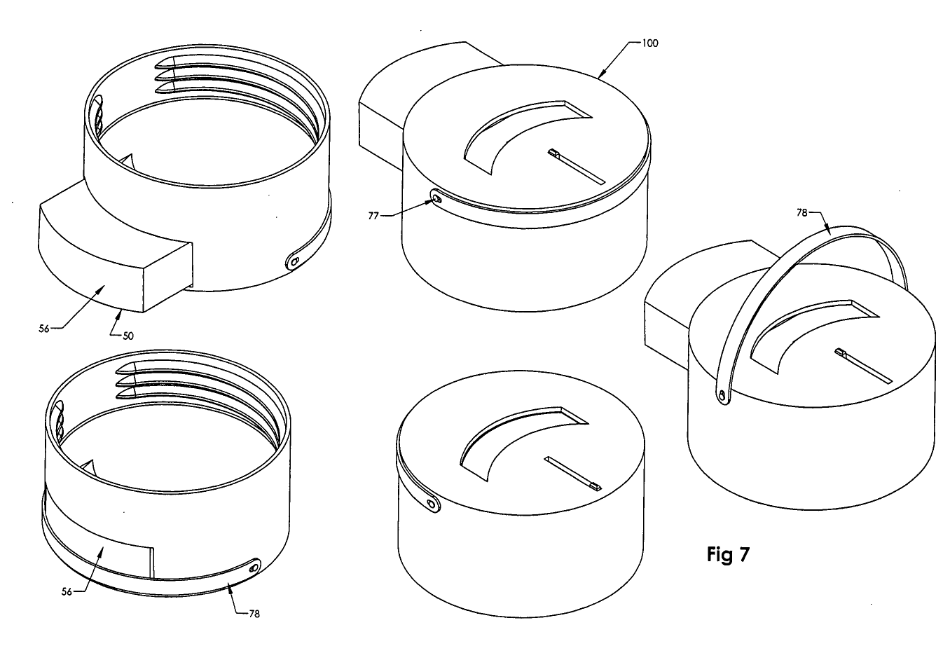

A further example of a locking mechanism is shown in FIG. 7, where a bail is rotatably attached to the cap body 100 at journals 77, the journals being on opposite ends of a diameter of the cap body 100. The bail 78 may be positioned so that it is opposite the aperture 55 in the cap body 100, through which the slide drawer 50 may protrude. In this state, the slide drawer 50 may be positioned in any of the states previously described for dispensing material. In another state, the bail 78 is positioned such that the slide drawer 50 is captivated by the bail 78 and the drawer is retained in a closed position with respect to the cap body 100.

Additional locking mechanisms may include various slide mechanisms in the surface 12 of the cap body 100 which may permit a tab to be positioned at the end 56 of the slide drawer 50 in a locked position, and moved vertically towards the container so that the movement of the slide drawer 50 is no longer impeded and the slide drawer 50 may be in an open position.

Although only a few exemplary embodiments have been described in detail above it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents. In the claims, means-plus-function clauses are intended to cover the structures described herein as performing the recited function, their structural equivalents and equivalent structures.

1. A dispensing cap for a container, comprising:
a cap body, comprising:
a cylindrical portion adapted to connect to the container;
a first surface disposed between a distal end and a proximal end of the cylindrical portion a second surface disposed near a proximal end of the cylindrical portion;
a first aperture in the first surface and a second aperture in the second surface; and
a drawer, comprising:
two opposing side walls;
a first end wall;
a first drawer surface and a second drawer surface spaced apart and connected by the opposing side walls, the first end wall connected to at least one of the first or the second surface;
a first chamber aperture in the first drawer surface facing a second chamber aperture in the second drawer surface, corresponding edges of the first and second chamber apertures being connected by walls perpendicular to the first drawer surface and the second drawer surface;
wherein the cylindrical portion has an aperture sized and dimensioned to accept the shuttle drawer, and the cylindrical portion is configured to permit the drawer to slide freely in a space between the first and the second surfaces, and at least one of the edges of each of the first and second chamber apertures has an arcuate shape.

2. The device of claim 1, wherein the volume defined by the first chamber aperture, the second chamber aperture and the walls connecting the first and second chamber aperture is determined so as to supply a known quantity of material to be dispensed.

3. The device of claim 1, wherein the arcuate shape is approximately a portion of a circumference of a circle, and the radius of the corresponding circle lies between about twice and about half of the radius of the cylindrical portion.

4. The device according to claim 1 where the radius of the cylindrical portion is approximately equal to the radius of an opening in the container.

5. The device according to claim 1, wherein a spring is disposed between a second end wall of the drawer and an interior surface of the cylindrical portion, such that the spring urges the second end wall of the drawer away from the interior surface of the cylindrical portion.

6. The device according to claim 5, wherein a mandrill is disposed along the spring axis, the mandrill disposed being orthogonal to the interior wall of the cylindrical surface.

7. The device of claim 1, wherein the shapes of the first aperture and the first chamber aperture are congruent.

8. The device of claim 1 wherein the shapes of the second aperture and the second chamber aperture are congruent.

9. The device of claim 1, wherein the shapes of the first aperture, the first chamber aperture, the second aperture and the second chamber aperture are congruent.

10. The device of claim 1 wherein the longitudinal offset between the closest edges of the first aperture and the second aperture is at least equal to the longitudinal width of the first chamber aperture.

11. The device of claim 1, further comprising a container having a substantially circular dispensing opening.

12. The device of claim 1, wherein the cylindrical portion is adapted to connect to the container by screw threads sized and dimensioned to mate with corresponding structures on the container.

13. The device of claim 1, wherein the cylindrical portion is adapted to connect to the container by one of gluing, clamping, or resistance welding.

14. The device of claim 1, wherein a slot or groove is formed in the second surface adapted to slidably engage with a tab formed on the second drawer surface to limit the linear distance of travel of the drawer.

15. The device of claim 1, wherein a boss is formed on the second drawer surface and disposed to mate with a hole formed in the second surface when the drawer is fully inserted into the cap body.

16. The device of claim 15, wherein the boss is disposed on deformable portion of the second surface such that the tab may be depressed by finger pressure to disengage from the hole.

17. A material dispensing device for a container, comprising:
a cap body, further comprising:
means for receiving a drawer, the drawer having a chamber having at least one arcuate surface, the means for receiving being attached to the container;
means for filling the chamber in the drawer with material from the container;
means for positioning the drawer so material filled in the drawer is dispensed outside of the container

18. The device of claim 17, further comprising:
means for restraining the drawer in a closed position with respect to the cap body.

19. The device of claim 17, further comprising:
means for urging the drawer to an open position with respect to the cap body.
